(19) United States
(12) Patent Application Publication
(10) Pub. No.: US 2018/0110180 A1
(43) Pub. Date: Apr. 26, 2018

(54) AGRICULTURAL SEEDER

(71) Applicant: Morris Industries Ltd., Saskatoon (CA)

(72) Inventors: Clint W. Sheppard, Yorkton (CA); Jody J. Klassen, Yorkton (CA); Ryan Lee Green, Yorkton (CA)

(73) Assignee: Morris Industries Ltd., Saskatoon (CA)

(21) Appl. No.: 15/794,987

(22) Filed: Oct. 26, 2017

Related U.S. Application Data
(60) Provisional application No. 62/413,334, filed on Oct. 26, 2016.

(51) Int. Cl. A01C 7/06

(52) U.S. Cl. CPC A01C 7/06; A01C 7/128

(57) ABSTRACT

An agricultural implement including an agricultural system operable to deposit product into soil. The agricultural system comprises a first blade configured to form a first furrow within the soil, and a second blade configured to form a second furrow within the soil. The agricultural system further includes a walking beam including a front portion, a rear portion, and a pivot portion between the front portion and the rear portion. The walking beam is configured to rotate about an axis presented by the pivot portion. Furthermore, the first blade is secured to the front portion of the walking beam, and the second blade is secured to the rear portion of the walking beam.

### CROSS-REFERENCE TO RELATED APPLICATION

This non-provisional patent application claims priority to U.S. Provisional Patent Application Ser. No. 62/413,334, entitled “INDEPENDENTLY DEPTH CONTROLLED DISC OPENER AND SHANK OPENER MOUNTED TO COMMON WALKING BEAM,” filed on Oct. 26, 2016. The entirety of the above-identified provisional patent application is hereby incorporated by reference into the present non-provisional patent application.

### FIELD OF THE INVENTION

The present disclosure generally relates to an agricultural system, such as a seeder, and method of use. More particularly, the present invention is directed to an agricultural seeder and a method for simultaneously depositing seed and fertilizer into the ground.

### BACKGROUND

Agricultural seeders, such as single-disc seeders and shank/hoe-drill seeders, have long been used as effective seeding tools for direct seeding into unprepared crop fields. However, such previously-used seeders have several drawbacks. For instance, with some single-disc seeders, there is a limitation to the amount of seed and/or fertilizer that can be placed within a furrow formed by the single disc due to the narrowness of the resulting furrow. Furthermore, because high rates of fertilizer in close proximity to the seed can lead to localized toxicity of the soil and, thus, significant seedling mortality, farmers must take care to place fertilizer in a separate location in the soil (i.e., spaced apart from the seed) or to use reduced amounts of fertilizer.

To prevent problems with seedling mortality while maintaining required fertilizer application rates for proper crop development, currently-available agriculture seeders generally rely on two different seeding technologies, each being a “double-shoot” technology. A first type of agricultural seeder that uses double-shoot technology incorporates the use of a single-disc opener or blade for seed placement and a separate single-disc opener or blade, laterally offset from the first single-disc opener, that places fertilizer separately into the ground. Such an agricultural seeder can be configured such that for every pair of seed disc openers, there is one fertilizer disc opener therebetween for placing fertilizer that can be used by the seed deposited by both adjacent seed disc openers. By placing one fertilizer disc opener between each pair of disc openers, fertilizer placement can be maintained at a safe distance from the seed. For example, for a typical 10-inch spacing between seed disc openers, the fertilizer disc opener might be positioned approximately five inches laterally away from the seed disc openers.

While the seed to fertilizer separation distance is effectively maintained by the above-described agricultural seeder, there are some drawbacks. First, such agricultural seeders require a dedicated set of fertilizer disc openers to place fertilizer midway between the seed rows, leading to added cost, high penetration force requirements, and additional draft forces to pull all the disc openers through the ground. Second, due to the nature of furrow formation with a single disc opener, a smear layer can be formed under a depth-gauge wheel of the agricultural seeder, whereby the disc opener has displaced the soil to the side to form the furrow. Such a smear layer makes it difficult to close the furrow once fertilizer has been deposited into the ground. As such, the fertilizer disc opener must have provisions for properly breaking down such a smear layer and covering over the furrow to prevent loss of fertilizer products to atmosphere. Third, single-disc seed openers are known to “hair pin” straw into the furrow rather than cut through straw. If straw is pushed into the furrow and not cut, it can prevent seed to soil contact, causing poor germination. Straw inclusion can also wick moisture out of the furrow leading to a dry seed bed. Finally, problems may develop due to the relatively large separation distance between seed and fertilizer, which can be problematic for certain types of fertilizer like phosphate. Phosphate fertilizer is not mobile in the soil and cannot diffuse away from the fertilizer furrow towards the seed furrow like other nutrients. As such, phosphate that is placed in a fertilizer furrow situated between a pair of seed furrows is likely to be stranded too far away from the seed furrows to be utilized by the deposited seed and/or the resulting crop.

The second type of agricultural seeder that uses double-shoot technology involves the use of a disc scraper in conjunction with a single-disc opener. The disc scraper is configured in such a way that the disc scraper rides against the disc opener and allows fertilizer to drop down to a bottom of the furrow opened by the disc opener. Simultaneously, a protruding wing on a side of the disc scraper cuts a seed shelf in the soil, to a side of the furrow, and deposits seed on the shelf. This agricultural seeder also has drawbacks, however. For instance, in wet conditions, the wing of the disc scraper is prone to buildup of soil and mud, leading to a large amount of soil disturbance. Significant soil disturbance can reduce seeding speeds and can cause some deposited seed to be buried deeply in soil thrown from other rows, leading to uneven emergence. Furthermore, the above-described agricultural seeder requires a large amount of penetration force to facilitate penetration of the seed disc opener and the wide wing scraper into the ground. Finally, in loose or very friable soil conditions, the shape of the furrow between the fertilizer and the seed can become unreliable and poorly formed, leading to seed and fertilizer products mixing in the furrow. With a high degree of fertilizer and seed mixing, seedling mortality will be generally higher than desired.

A final alternative agricultural seeding system includes the use of a separate front row of fertilizer disc openers and three rearward-mounted rows of hoe/shank openers to place seed. However, such as system results in a large heavy machine that has multiple sets of row systems to achieve separation of fertilizer and seed for single-pass seeding operation.

### BRIEF SUMMARY

Embodiments of the present invention include an agricultural implement including an agricultural system operable to deposit product into soil. The agricultural system comprises a first blade configured to form a first furrow within the soil, and a second blade configured to form a second furrow within the soil. The agricultural system further includes a walking beam including a front portion, a rear portion, and a pivot portion between the front portion and the rear portion. The walking beam is configured to rotate about an axis presented by the pivot portion. Furthermore, the first blade is secured to the front portion of the walking beam, and the second blade is secured to the rear portion of the walking beam.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of embodiments of the present invention. Wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 is a side elevation view of an agricultural system according to embodiments of the present invention;

FIG. 2 is a perspective exploded view of the agricultural system from FIG. 1;

FIG. 3 is a top plan view of a plurality of agricultural systems being attached to an implement frame, with the plurality of agricultural systems each being propelled through a field to deposit a first product and a second product within a first furrow and a second furrow, respectively;

FIG. 4 is side elevation view of the agricultural system from FIGS. 1 and 2, with the agricultural system engaged with the ground to form a first furrow and a second furrow and to deposit a first product into the first furrow and a second product into the second furrow;

FIG. 5 is a rear elevation view of the agricultural system from FIG. 4;

FIG. 6 is a side elevation view of the agricultural system from FIGS. 1 and 2, further illustrating forces imparted upon the agricultural system to generate rotational moments;

FIG. 7 is a rear perspective view of the agricultural system from FIGS. 1 and 2, illustrating the agricultural system engaged with the ground and encountering an obstacle buried within the ground;

FIG. 8a is a side elevation view of the agricultural system from FIG. 7 encountering the obstacle buried in the ground;

FIG. 8b is a side elevation view of the agricultural system from FIG. 8a, illustrating a first blade of the agricultural system being forced upward by the obstacle, with a second blade of the agricultural system remaining at least partially embedded within the ground;

FIG. 8c is a side elevation view of the agricultural system from FIGS. 8a and 8b, illustrating the first blade of the agricultural system having moved past the obstacle, with both the first blade and the second blade being embedded within the ground; and

FIG. 8d is a side elevation view of the agricultural system from FIGS. 8a-8c, illustrating the second blade of the agricultural system being forced upward by the obstacle, with the first blade of the agricultural system remaining at least partially embedded within the ground.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

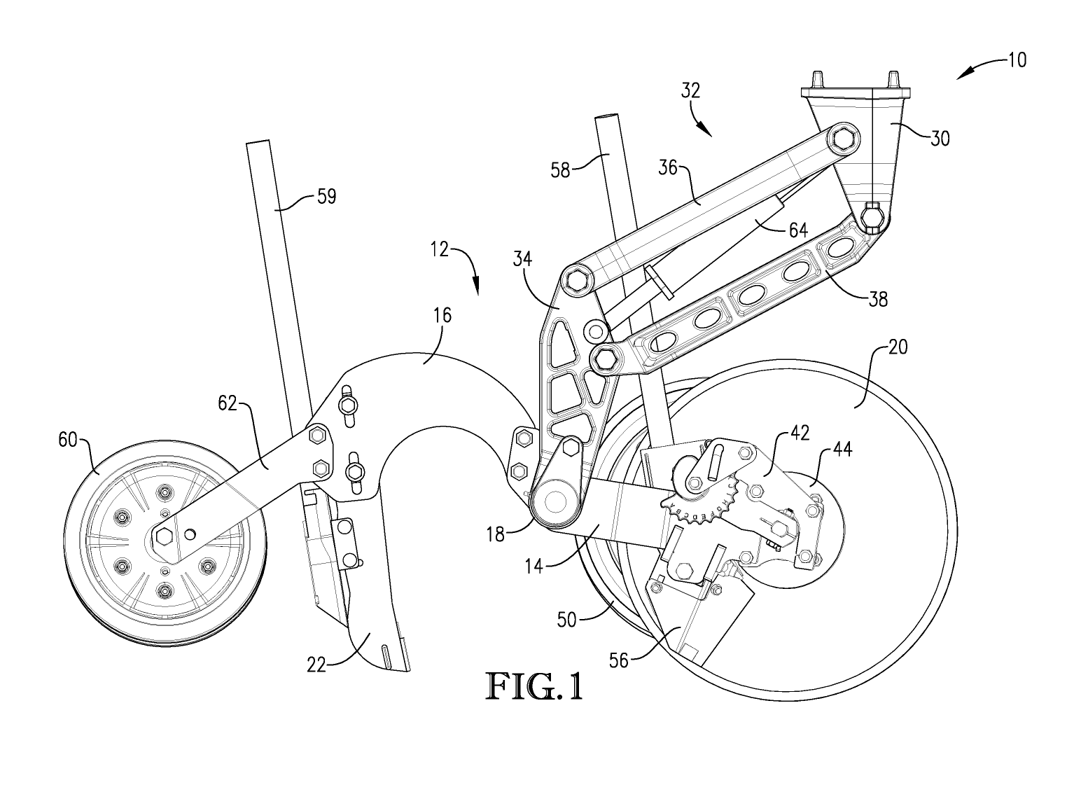

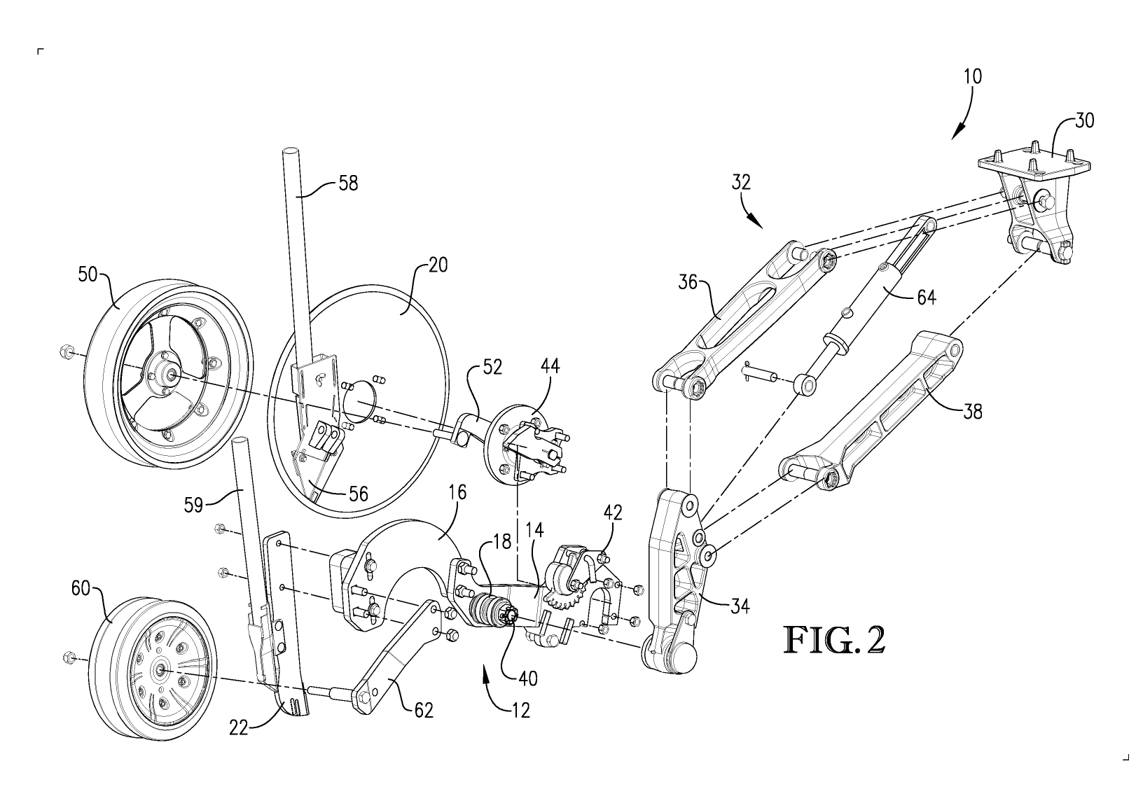

Embodiments of the present invention relate to, inter alia, agricultural systems and methods for depositing product into soil. An exemplary agricultural system 10, in the form of an agricultural seeder, is illustrated in FIGS. 1 and 2 and broadly comprises a walking beam 12 that includes a front portion 14, a rear portion 16, and a pivot portion 18 opposed between portions of the front portion 14 and the rear portion 16. For example, the front portion 14 of the walking beam 12 may extend forward with respect to the pivot portion 18, while the rear portion 16 may extend rearward with respect to the pivot portion 18. As such, the pivot portion 18 may be positioned between a front end and a rear end of the walking beam 12. The agricultural system 10 may additionally include a first blade 20 secured to the front portion 14 of the walking beam 12, with the first blade 20 being configured to form a first furrow within the soil. The agricultural system 10 may further include a second blade 22 secured to the rear portion 16 of the walking beam 12, with the second blade 22 being configured to form a second furrow within the soil. The above-described agricultural system 10 is configured to simultaneously deposit a first product, such as fertilizer or pesticide, and a second product, such as crop seeds, into the soil. Beneficially, however, the first and second products can be deposited in spaced apart furrows, such that the products do not damagingly interfere with each other.

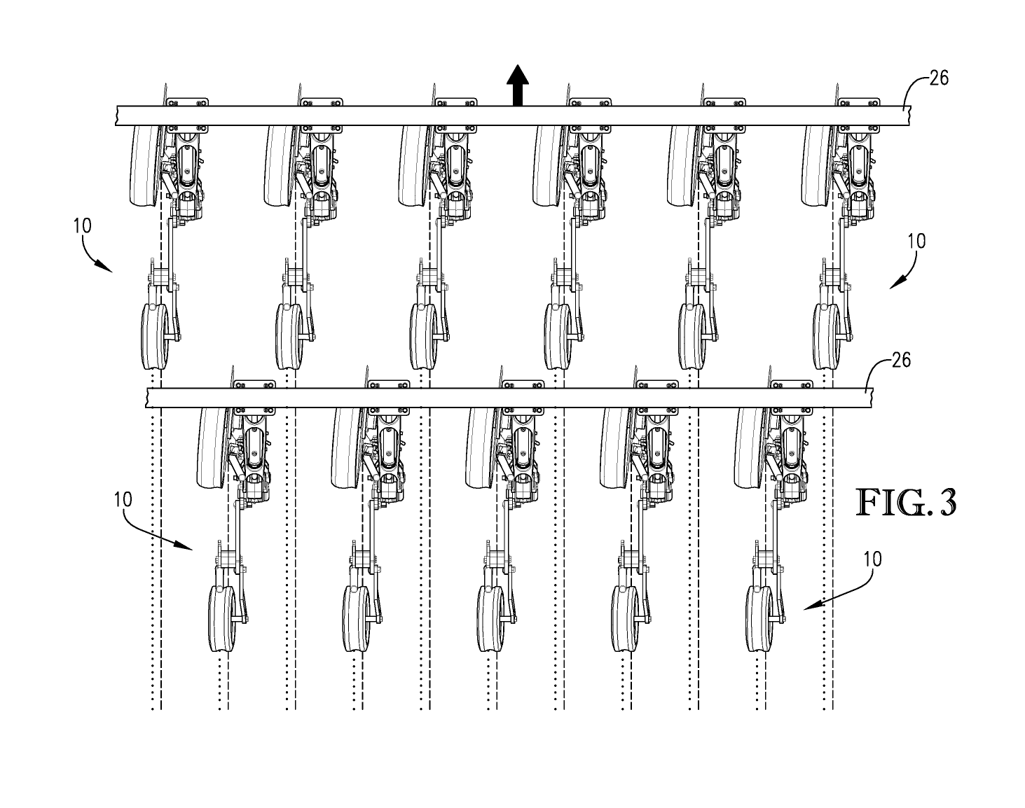

The agricultural system 10 may be propelled (i.e., pulled or pushed) by way of various types of agricultural equipment, such as a tractor (not shown). A plurality of agricultural systems 10 may, as illustrated in FIG. 3, be secured to tool bars 26 of a frame of an agricultural implement, which can itself be propelled by the tractor. As such, under power of the tractor, the implement frame can carry a plurality of agricultural systems 10 so as to deposit a plurality of rows of products into the ground. As will be described in more detail below, each agricultural system 10 can simultaneously deposit a row of seed in a seed furrow and a row of fertilizer in a fertilizer furrow, with the seed furrow being offset from the fertilizer furrow so as to reduce seedling mortality by damaging effects of the fertilizer being deposited too close to the seed.

With reference to FIGS. 1 and 2, each agricultural system 10 may be secured to the implement frame by way of a bracket 30, which is configured to be secured to one of the tool bars 26 of the implement frame (See FIG. 3). The agricultural system 10 may extend downward from the implement frame via a linkage assembly 32, which extends from the bracket 30 to a pivot member 34. The linkage assembly 32 may include an upper linkage element 36 and a lower linkage element 38, which are vertically spaced apart from one another. The linkage elements 36, 38 may comprise various types of elements, such as bars, beams, girders, joists, and the like. Each of the linkage elements 36, 38 may be rotationally secured, at its ends, to both the bracket 30 and to the pivot member 34. Such rotational connections may be made by way of pivot pins, ball joints, bearing assemblies, or the like. For instance, as shown in FIGS. 1 and 2, the linkage elements 36, 38 may be rotationally connected to upper and lower portions, respectively, of the bracket 30 via pins. Similarly, the linkage elements 36, 38 may be rotationally connected to the pivot member 34 in a spaced apart manner adjacent to an upper end of the pivot member 34 via pins. Each of the above-described components, e.g., the bracket 30, linkage assembly 32, and the pivot member 34, may be formed from iron, steel, or another high-strength material capable of permitting the agricultural system 10 to perform seeding operations, as will be discussed in more detail below. In the illustrated embodiment, the linkage elements 36, 38 may be connected to form a 4-bar linkage (in cooperation with the bracket 30 and the pivot member 34), although alternative linkage arrangements, number of linkages elements, or the like, may be used without departing from the spirit of certain aspects of the present invention.

As is illustrated in FIGS. 1 and 2, the pivot member 34 may be coupled in a rotational manner with the walking beam 12, such that the walking beam 12 can rotate through a set angular range of travel with respect to the pivot member 34. Specifically, as shown in FIGS. 1 and 2, the walking beam 12 may be rotationally coupled with the pivot member 34 at a position adjacent to a bottom end of the pivot member 34. Such coupling may be formed by way of a pivot element 40 (See FIG. 2), such as a pin, extending laterally from the walking beam 12 for securement within a receiving port of the pivot member 34. It should be understood that in some embodiments, the pivot element 40 may form at least part (or all) of the pivot portion 18 of the walking beam 12. As such, the pivot element 40 may present a rotational axis about which the walking beam 12 is configured to rotate. In alternative embodiments, a pivot element, such as a pin, may extend from the pivot member 34 for securement within a receiving port of the pivot portion 18 of the walking beam 12.

Turning now to the walking beam 12 in more detail, the walking beam may broadly comprise the front portion 14 extending forward from the pivot portion 18, and the rear portion 16 extending rearward from the pivot portion 18. In some embodiments, the pivot portion 18 may be formed as a part of either the front or rear portions 14, 16. For example, as shown in FIGS. 1-2, the pivot portion 18 may be positioned adjacent to a back end of the front portion 14, extending laterally therefrom towards the pivot member 34. As noted above, the pivot portion 18 may comprise a pivot element 40, such as a pin, that extends outward for connection with the pivot member 34. However, it should be understood that other types of rotational connections may be used, such as ball joints, bearing assemblies, or the like.

In more detail, the front portion 14 may extend forward from the pivot portion 18. In some embodiments, the front portion 14 may extend forward in a generally linear manner. However, a front end of the front portion 14 may include one or more securement/adjustment components 42 for securing a hub 44 thereto and for making adjustments to the hub 44. As will be described in more detail below, the hub 44 may be used to rotatably secure the first blade 20 to the walking beam 12.

The rear portion 16 of the walking beam 12 may, in some embodiments, extend rearward with respect to the pivot portion 18 in a generally arcuate manner. For instance, as shown in FIGS. 1 and 2, the rear portion 16 may have an arcuate shape, with the rear end of the rear portion 16 extending at least partly downwards such that the rear portion 16 presents a concave surface when viewed from a bottom of the rear portion 16. In some embodiments, the front portion 14, the pivot portion 18, and the rear portion 16 may be comprised of a unitary piece of material, such as a unitary piece of iron or steel. However, in other embodiments, one or more of the front portion 14, the pivot portion 18, and/or the rear portion 16 may be individual elements that can be secured together. For example, as shown in FIGS. 1-2, the rear portion 16 may be rigidly secured to the front portion 14 via nut and bolt combinations or some other securement mechanism.

Embodiments provide for the first blade 20 to be rotatably secured to the front portion 14 of the walking beam 12 via the hub 44. The first blade 20 may comprise various types of openers or blades configured to form a furrow within the soil when propelled through the soil. For example, as shown in FIGS. 1 and 2, the first blade 20 may comprise a rotatable disc blade that that has an angular offset of between four (4) and eight (8) degrees from a direction of travel of the agricultural system 10. As such, as the first blade 20 is propelled through the soil, the first blade 20 can form a furrow in the soil that extends along a line through which the first blade 20 has traveled. In other embodiments, the first blade 20 and the hub 44 may be replaced by a pair of double disc blades secured to the agricultural system 10 via a bearing assembly.

A depth of the furrow created by the first blade 20 may be controlled by adjusting a depth that the first blade 20 extends within the soil. Such depth may be controlled by a gauge wheel 50 positioned to a side of the first blade 20. The gauge wheel 50 is configured to roll along a surface of the soil next to the first blade 20, as the first blade 20 extends down into and cuts through the soil to form a furrow. The gauge wheel 50 may be rotatably connected to the hub 44 via a gauge wheel arm 52, as illustrated in FIG. 2. The position of the gauge wheel 50 may be changed by adjusting the position and/or orientation of the gauge wheel arm 52 by way of the securement/adjustment components 42. As such, embodiments provide for the gauge wheel 50 and the first blade 20 to be vertically shiftable with respect to each other. Specifically, bottoms of the gauge wheel 50 and of the first blade 20 are vertically shiftable with respect to each other. Thus, when the gauge wheel 50 is shifted upward (i.e., upward with respect to the first blade 20), the first blade 20 will extend further down within the soil, while the gauge wheel 50 continues to be positioned on the surface of the soil. As a result, the furrow created by the first blade 20 will be deeper. In contrast, when the gauge wheel 50 is shifted downward (i.e., downward with respect to the first blade 20), the first blade 20 will extend down within the soil to a lesser extent, while the gauge wheel 50 continues to be positioned on the surface of the soil. As a result, the furrow created by the first blade 20 will be less deep. In some alternative embodiments, a spiked-closing wheel may be used in place of or in addition to the gauge wheel 50 to assist in breaking down compacted soil left by the first blade 20 before the second blade 22 passes through such compacted layer (as will be described in more detail below).

As illustrated in FIGS. 1 and 2, embodiments provide for the agricultural system 10 to further include a disc scraper 56, which can be position against a side of the first blade 20 opposite the gauge wheel 50. The disc scraper 56 may have a blade edge that is positioned adjacent to the side of the first blade 20, such that the disc scraper 56 can remove buildups of soil that may accumulate on the side of the first blade 20 as the first blade 20 rotates and travels through the soil.

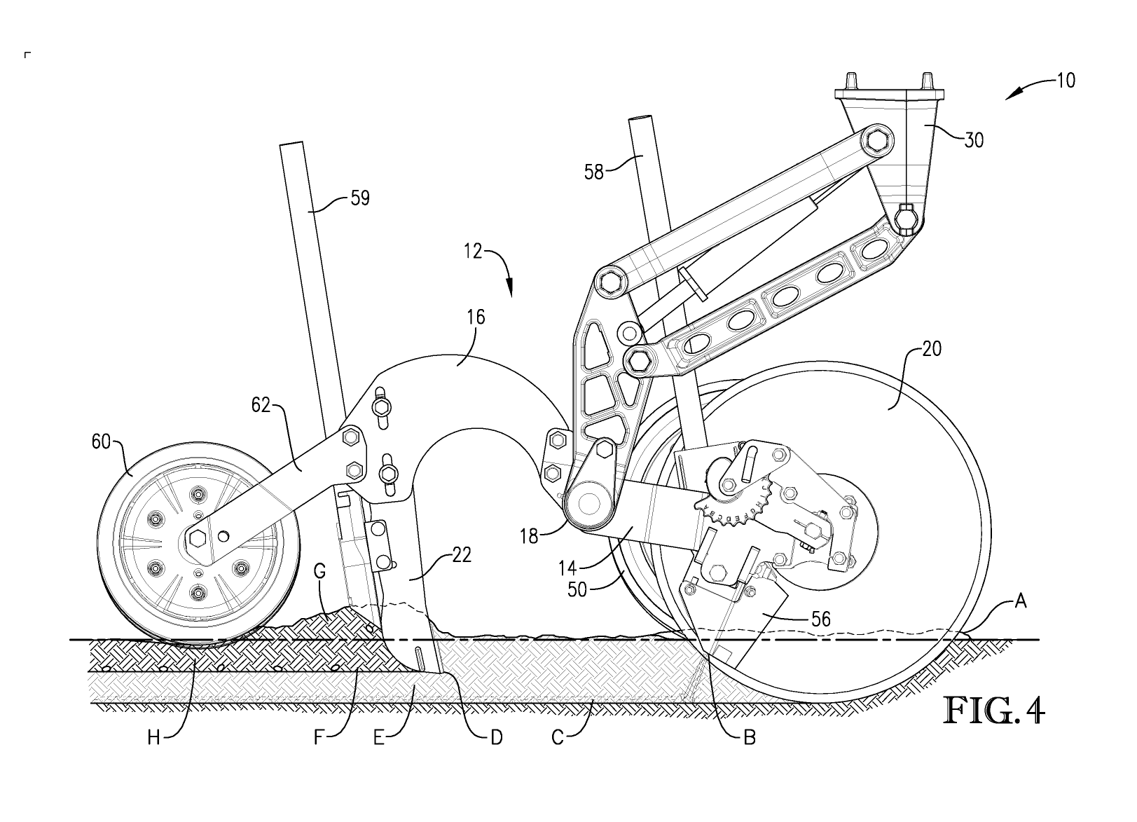

The disc scraper 56 may extend at an angle from the first blade 20 so as to form a product pocket positioned between the first blade 20 and an exterior of the disc scraper 56. In some embodiments, when the agricultural system 10 is engaged with the ground as illustrated in FIG. 4, the disc scraper 56 may extend at least partially within the furrow created by the first blade 20. As such, a portion of the product pocket presented between the first blade 20 and the disc scraper 56 may also be positioned within the furrow. A first product delivery component 58, such as a plastic, hollow tube, hose, line, or the like may extend down from the implement frame to within the product pocket. Some embodiments may provide for the first product delivery component 58 to be secured within a portion of the disc scraper 56 and/or within the product pocket, such that a free end of the first product delivery component 58 can be positioned within or adjacent to the furrow. As such, the first product delivery component 58 can be configured to deposit a first product within the furrow created by the first blade 20. The first product delivery component 58 may be connected to a supply or a source of first product. In some embodiments, the first product may comprise substances that enhance viability of seeds and/or health of the soil. For example, the first product may comprise liquid, granular, or high pressure gaseous fertilizers, pesticides, or the like.

Turning now to the second blade 22, the second blade 22 may be secured to the rear end of the rear portion 16 of the walking beam 12. The second blade 22 may be selected from various types of blades capable of forming a furrow within the ground, such as a shank, a disc blade, moldboard plow, ridge plow, chisel plow, or the like. As illustrated in FIGS. 1, 2, and 4, the second blade 22 may comprise a shank that extends downward from the back end of the rear portion 16 of the walking beam 12. As shown, the shank may include a sharpened front edge that faces a direction of travel of the agricultural system 10 so as to form a furrow within the soil as the shank is propelled through the ground. The second blade 22 may be secured to the walking beam 12 via various methods of attachment, such as nut and bolt combinations.

In some embodiments, the second blade 22 may be associated with a second product delivery component 59, such as a hollow, plastic tube, hose, line, or the like. The second product delivery component 59 may be configured to extend down from the implement frame to a position rearward of the second blade 22, such that the second product delivery component 59 can deliver a product into the furrow formed by the second blade 22. In some embodiments, the second blade 22 may have a housing attachment that receives an end portion of the second product delivery component 59 so as to maintain the second product delivery component 59 in a position necessary to direct product into the furrow formed by the second blade 22. The second product delivery component 59 may be connected to a supply or a source of second product. In some embodiments, the product delivered by the second product delivery component 59 may include crop-producing seeds.

A depth of the furrow formed by the second blade 22 may be controlled by a packer wheel 60, as is illustrated in FIGS. 1, 2, and 4. The packer wheel 60 may be secured to the back end of the rear portion 16 of the walking beam 12 via a packer wheel arm 62. Specifically, the packer wheel 60 may be rotatably secured to a rear end of the packer wheel arm 62, while the front end of the packer wheel arm 62 is rigidly secured to the walking beam 12. As such, the packer wheel 60 is configured to roll across the surface of the ground, while the second blade 22 extends down within the soil to form the furrow.

Certain embodiments provide for the depth of the furrow created by the second blade 22 to be adjusted by vertically shifting the positions of the second blade 22 and/or the packer wheel 60 with respect to each other. Specifically, bottoms of the packer wheel 60 and second blade 22 may be vertically shiftable with respect to each other. For instance, as illustrated in FIGS. 1 and 2, a vertical position of the second blade 22 may be adjusted by shifting bolts that secure the second blade 22 to the walking beam 12 within elongated openings formed through the walking beam 12. Thus, when the second blade 22 is shifted downward (i.e., downward with respect to the packer wheel 60), the second blade 22 will extend further down within the soil, while the packer wheel 60 continues to be positioned on the surface of the soil. As a result, the furrow created by the second blade 22 will be deeper. In contrast, when the second blade 22 is shifted upward (i.e., upward with respect to the packer wheel 60), the second blade 22 will extend down within the soil to a lesser extent, while the packer wheel 60 continues to be positioned on the surface of the soil. As a result, the furrow created by the second blade 22 will be less deep. In alternative embodiments, the packer wheel 60 may be vertically shiftable with respect to the second blade 22. For example, the packer wheel arm 62 may be rotatably adjustable so as to provide for the packer wheel 60 to be vertically adjusted.

The overall vertical position of the agricultural system 10 may be shifted with respect to the implement frame via an actuator 64, as illustrated in FIGS. 1 and 2. Such actuator 64 may also be used to create the downward force on the walking beam 12, which is distributed to the first blade 20 and the second blade 22 for penetrating into the soil. In some embodiments, the actuator 64 may comprise a hydraulic cylinder. However, it should be understood that other electrical, mechanical, or pneumatic actuators may, alternatively, be used. In further alternatives, compression or tension springs, rubber-spring torsion systems, or another type of biasing means may be used as the actuator 64. In some embodiments, a first end of the actuator 64 may be rotatably secured to the bracket 30, such as by way of a pin. In some embodiments, the actuator 64 may be secured to the bracket 30 at a position that coincides with the position at which the upper linkage element 36 is connected to the bracket 30 (e.g., the actuator 64 and the upper linkage element 36 share a common pivot pin). In other embodiments, the actuator 64 may be secured to the bracket 30 between the upper and lower linkage elements 36, 38. Furthermore, a second end of the actuator 64 may be rotatably secured to the pivot member 34, such as by way of a pin. In some embodiments, the actuator 64 may be secured to the pivot member 34 at a position spaced between the upper and lower linkage elements 36, 38. As such, actuation of the actuator 64 may provide for the agricultural system 10 to be raised and lowered with respect to the implement frame between a raised position and a lowered position.

In the raised position, the components of the agricultural system 10 may be entirely extracted from and spaced apart above the ground. In such a raised position, the tractor can propel the implement frame relatively unimpeded. Alternatively, in the lowered position, such as illustrated in FIG. 4, the agricultural system 10 can be engaged with the ground so as to form furrows within the soil and to deposit product within the formed furrows. Specifically, the first blade 20 can form a first furrow within the soil, such that the first product delivery component 58 can deposit a first product, such as fertilizer, within the first furrow. In addition, the second blade 22 can form a second furrow within the soil, such that the second product delivery component 59 can deposit a second product, such as seed, within the second furrow. Beneficially, the agricultural system 10 can be configured such that the first furrow and the second furrow are offset from one another, such that the first product and second product do not improperly interfere with each other. As was previously described, for example, some fertilizers can be destructive or deadly to certain seeds if the fertilizer comes into contact with and/or is positioned sufficiently close to the seed. As such, preferred embodiments of the present invention provide for the first and second furrows to be offset from one another to minimize such damaging interference.

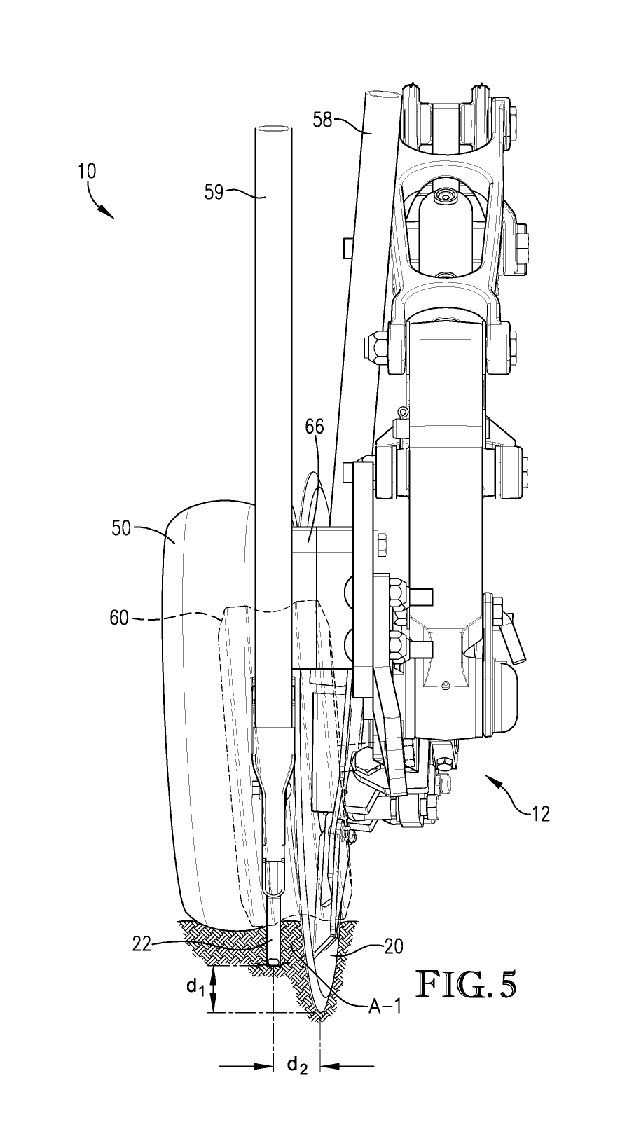

As illustrated in FIG. 5, the first furrow created by the first blade 20 may be vertically offset below the second furrow created by the second blade 22 by a distance “d1.” In addition, the first furrow may be laterally offset from the second furrow by a distance “d2.” In some embodiments, one or both of the distances d1 and/or d2 may be measured between bottoms of the respective furrows. Embodiments provide for the distances d1, d2 to be adjusted as may be necessary. For instance, the vertical distance d1 may be adjusted by vertically adjusting the depth(s) of the first blade 20 and/or second blade 22, as was previously described. The lateral distance d2 may be established by the configuration of the walking beam 12, which can set a lateral spacing between the first blade 20 and the second blade 22. However, some embodiments may provide for the distance d2 to be further adjusted. For instance, the securement components that secure the second blade 22 to the walking beam 12 may include one or more spacing elements 66, as shown in FIG. 5, which permits the second blade 22 to be positioned at a specified lateral distance d2 from the first blade 20. Although the lateral separation distance d2 is shown extending from the first blade 20 towards the second blade 22 in a direction away from the walking beam 12. Other embodiments may provide for the separation distance d2 to extend in an opposite direction from the first blade 20. In such embodiments, the second blade 22 and/or the first blade 20 may be positioned on an opposite side of the walking beam 12.

Operation of the agricultural system 10 will now be described in more detail. As was discussed previously, a plurality of agricultural systems 10 may be secured to an implement frame, as shown in FIG. 3. A tractor can, thus, propel the plurality of agricultural systems 10 through a field by pulling the implement frame across the ground. Each agricultural system 10 may be lowered, via its actuator 64, to its lowered position into engagement with the ground, as is shown in FIGS. 4 and 5. Specifically, the first blade 20 can be embedded with the ground to form a first furrow through the soil as the agricultural system 10 is propelled across the ground. Simultaneously, the second blade 22 can be embedded within the ground to form the second furrow through the soil. As such, the agricultural system 10 can simultaneously form the first furrow and the second furrow into which a first product (e.g., fertilizer) and a second product (e.g., seed) can be respectively deposited. The first product and the second product can be delivered to the first product delivery component 58 and the second product delivery component 59, respectively, via any type of metered delivery system (not shown), that may be applicable for each type of product. Those of ordinary skill in the art will appreciate that the metering system may be interposed between respective product sources (or supplies) and the delivery components 58, 59.

While in operation, the actuator 64 may apply a biasing force to the walking beam 12 by way of the pivot member 34 and/or the linkage assembly 32 so as to maintain the first blade 20 and the second blade 22 embedded within the ground to form the first furrow and the second furrow within the soil. The applied biasing force may be split between the front portion 14 and the rear portion 16 of the walking beam 12. The amount of force that each portion 14, 16 of the walking beam 12 receives may be a result of a geometric distance from the respective portion 14, 16 to the pivot member 34 and/or to the pivot section 18 of the walking beam 12. In addition, the walking beam 12 may, as discussed above, be rotatably attached to the pivot member 34. As such, the walking beam can rotate through a set angular range of travel during operation in the field. Because the first blade 20 and the second blade 22 are secured to the front and the rear of the walking beam 12, respectively, the first blade 20 and the second blade 22 can be caused to raise and/or lower as the walking beam 12 rotates. Such ability provides for a terrain-following capability of the agricultural system 10. Specifically, as the agricultural system 10 encounters uneven terrain and/or obstacles in the ground, the walking beam 12 is permitted to rotate so as to allow the first blade 20 and the second blade 22 to be maintained embedded within the ground to perform efficient seeding operations (e.g., furrow formation and product depositing).

With reference to FIG. 4, as the agricultural system 10 travels through a field, the first blade 20, which may comprise a disc blade, can come into contact with the soil at point “A” and open up a first furrow within the soil behind the first blade 20. In embodiments in which the first blade 20 is a disc blade, the disc blade will create a compacted layer of soil on a lateral side of the first blade 20 (See point “A-I” on FIG. 5, which highlights the compacted layer of soil). As will be described in more detail below, the second blade 22 can be caused to travel through the compacted layer to break up the soil of the compaction layer and to cover the first product deposited in the first furrow. Beneficially, the first blade 20 functions to pre-cut any residue that may be present in the field, so as to improve residue clearance of the agricultural system 10. Embodiments provide for at least a portion of the disc scraper 56 to extend down within the first furrow created by the first blade 20 at point “B.” As such, a first product can be delivered into the bottom of the first furrow by way of the first product delivery component 58 that is positioned between the first blade 20 and the disc scraper 56.

As the agricultural system 10 continues travelling forward, the first product remains at the bottom of the first furrow, illustrated at point “C” in FIG. 4. Simultaneously, the second blade 22, which may comprise a shank, also travels forward through the compacted layer of soil left by the first blade 20, so as to disturb the soil next to the first furrow to create the second furrow at point “D.” As noted previously, the first furrow and the second furrow can be separated laterally (i.e., by distance d1) and vertically (e.g., by distance d2), as is illustrated in FIG. 5. Returning to FIG. 4, a portion of the soil disturbed to form the second furrow by the second blade 22 can be displaced laterally into the first furrow a point “E.” This soil displaced at point “E” may function to cover the first product deposited into the first furrow, so as to prevent the first product from being exposed to the atmosphere.

Upon the second furrow being formed by the second blade 22, the agricultural system 10 may deposit the second product (e.g., seed) into the second furrow at point “F,” as illustrated in FIG. 4, by way of the second product delivery component 59. In some embodiments, such as when the second blade 22 comprises a shank, the soil disturbed by the second blade 22 may be caused to flow (1) around the second blade 22 and the second product delivery component 59, such as is shown at point “G,” and (2) over top of the second product deposited at point “F.” Such a soil flow created by the second blade 22 may be used to cover over the second product that has been deposited into the second furrow. The soil overlying the second furrow can then be packed down firmly at point “H” by the packer wheel 60, as the packer wheel 60 rolls over the soil above the second furrow. In some embodiments, a width of packer wheel 60 may be sufficiently wide so that it can roll over and pack down soil over both the second furrow and the first furrow, thereby sealing both the first product and the second product in their respective furrows.

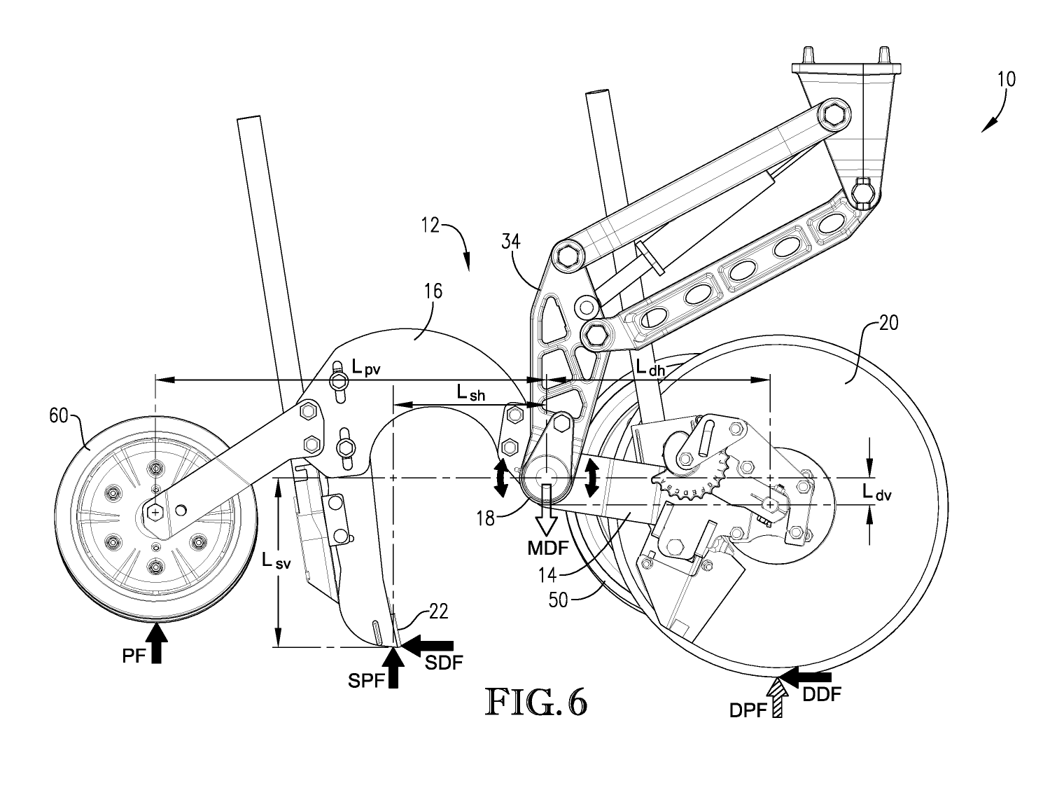

During operation, the agricultural system 10 according to embodiments of the present invention is configured to provide appropriate force distribution to its first and second blades 20, 22. FIG. 6 illustrates a force diagram of the agricultural system 10 in operation. A main down force MDF is a vertical force applied downwardly to the walking beam 12, as applied by the actuator 64 by way of the pivot member 34. A disc penetration force DPF is a vertical force, which is required to be overcome to push the first blade 20 into the soil so that the first blade 20 can form the first furrow. A disc draft force DDF is a horizontal force pushing rearward on the first blade 20 as the first blade 20 travels forward through the soil creating the first furrow. A shank penetration force SPF is a vertical force, which must be overcome to push the second blade 22 into the soil so that the second blade 22 can form the second furrow. A shank draft force SDF is a horizontal force pushing rearward on the second blade 22 as the second blade travels forward through the soil to form the second furrow. And, finally, a packer force PF is a remaining vertical force applied against the packer wheel 60 (and thus the walking beam 12) after the second blade 22 has penetrated the soil. Although not shown, another remaining vertical force may be applied against the gauge wheel 50 (and thus the walking beam 12) after the first blade 20 has penetrated the soil.

Embodiments of the present invention provide for the above-described forces to apply preferential rotational moments onto the walking beam 12, such that the walking beam 12 is operable to maintain the first blade 20 and/or the second blade 22 embedded within the ground to efficiently create their respective furrows. While the agricultural system 10 is engaged with the ground, the forces illustrated in FIG. 6 with solid arrows (e.g., DDF, SDF, SPF, SDF, and PF) are configured to cause a rotational moment about the pivot portion 18 of the walking beam 12 in a clockwise direction. The magnitude of the clockwise rotational moment is determined as the sum of the individual rotational moments, with the individual rotational moments defined as the product of the force and a length of a torque arm about which the force is applied. For example, the clockwise rotational moment of the agricultural system 10 may be defined as (the disc draft force “DDF” X the disc vertical distance “Ldv”)+(the shank draft force “SDF” X the shank vertical distance Lsv)+(the shank penetration force “SPF” X the shank horizontal distance Lsh)+(the packer force “PF” X the packer horizontal distance Lph). It is understood that the shank horizontal distance Lsh and the shank vertical distance Lsv are defined as the respective horizontal and vertical distances between the pivot portion 18 of the walking beam 12 and the tip of the second blade 22. The disc vertical distance Ldv is defined as the vertical distance between the pivot portion 18 of the walking beam 12 and the center (i.e., the rotational axis) of the first blade 20. Similarly, the packer horizontal distance Lph is defined as the horizontal distance between the pivot portion 18 of the walking beam 12 and the center (i.e., rotational axis) of the packer wheel 60.

Alternatively, the force illustrated with the diagonal-patterned arrow (e.g., DPF) is configured to cause a rotational moment about the pivot portion 18 of the walking beam 12 in a counter-clockwise direction. The magnitude of the counter-clockwise rotational moment is determined as the product of the disc penetration force DPF and the disc horizontal distance Ldh. The disc horizontal distance Ldh is defined as the horizontal distance between the pivot portion 18 of the walking beam 12 and the center (i.e., the rotational axis) of the first blade 20. In some embodiments, the upward force applied against the gauge wheel 50 (not shown) may provide an additional counter-clockwise rotational moment to the walking beam 12. Finally, it should be understood that the downward force imparted by the actuator 64 onto the pivot portion 18 of the walking beam 12, as illustrated by the hollow arrow (e.g., MDF) does not directly impart a rotational moment on the walking beam 18.

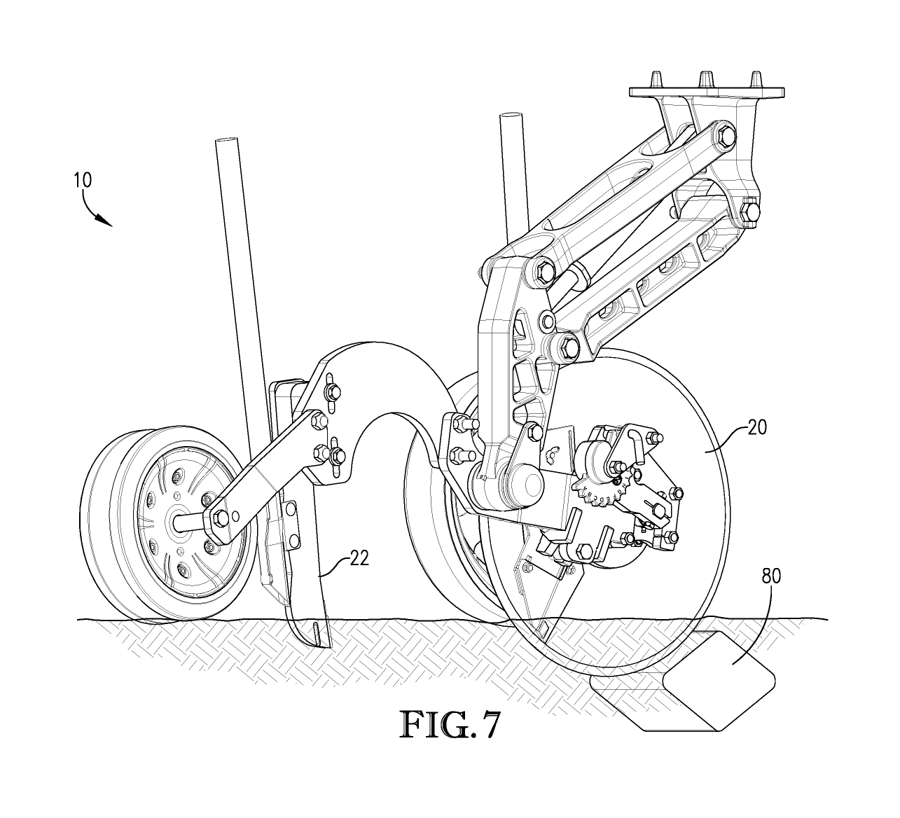

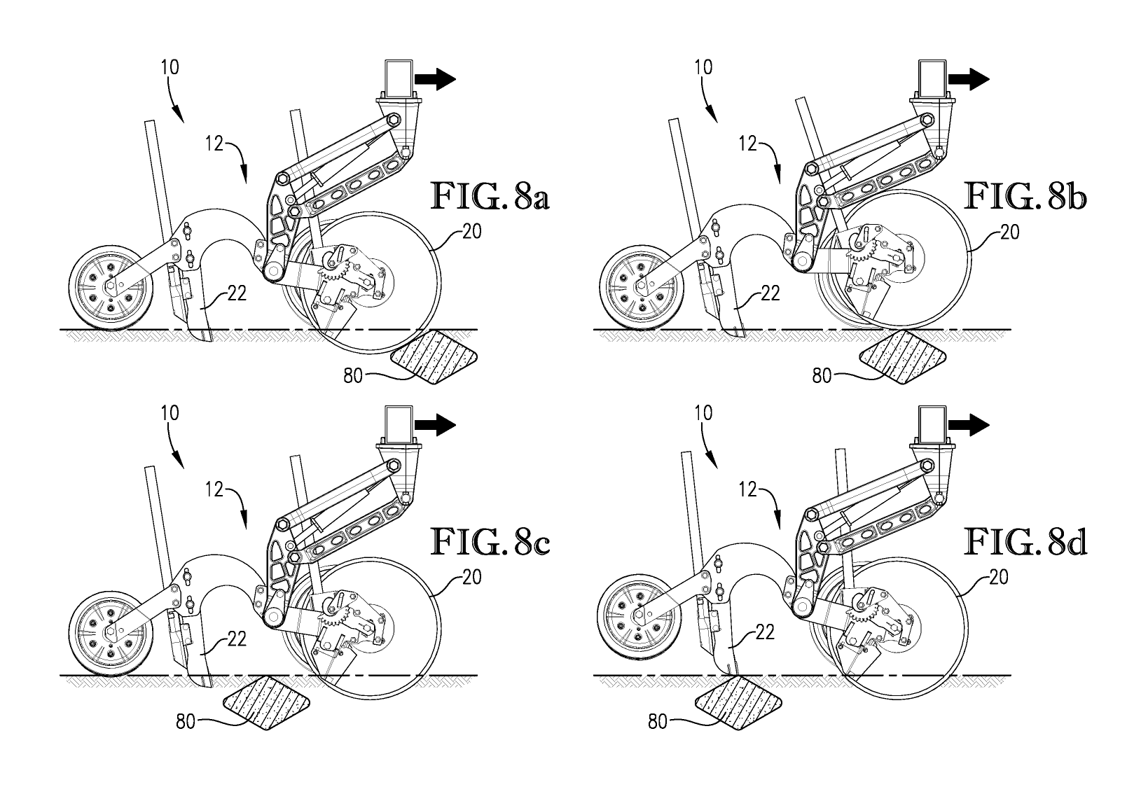

Given the forces described above, the configuration of the agricultural system 10 of embodiments of the present invention beneficially provides for improved performance during seeding operations even in problematic soil conditions, such as soil with rocks or other obstacles embedded therein. For example, FIGS. 7 and 8a-8d illustrate an agricultural system 10 that is operating in a field and encounters an obstacle, in the form of a rock 80 embedded within the soil. Beginning with FIGS. 7 and 8a, the agricultural system 10 is shown operating in a field and approaching the rock 80 buried within the soil. Before the agricultural system 10 encounters the rock, the agricultural system 10 is operating normally by forming first and second furrows via first and second blades 20, 22, respectively, and by depositing first and second products in such first and second furrows, respectively.

FIG. 8b shows the first blade 20 coming into contact with the rock 80 and being forced upward out of the ground. The upward force imparted by the rock 80 onto the first blade 20 is sufficient to cause a counter-clockwise rotational moment that overcomes any clockwise rotational moment of the walking beam 12. As such, the walking beam 12 will pivot counter-clockwise about the rotational axis presented by the pivot portion 18 of the walking beam 12. Such rotation will cause the second blade 22 to be forced downward, remaining embedded within the ground. As such, even with the first blade 20 being forced out of the ground, embodiments provide for the second blade 22 to continue to be at least partially embedded in the ground so as to continue forming the second furrow and to continue depositing the second product within the soil.

FIG. 8c illustrates the first blade 20 having moved past the rock 80 and being re-engaged within the soil. In such a position, both the first and second blades 20, 22 can form respective first and second furrows, such that the agricultural system 10 can deposit first and second product within such first and second furrows. FIG. 8d shows the second blade 22 coming into contact with the rock 80 and being forced upward out of the ground. The upward force imparted by the rock 80 onto the second blade 22 is sufficient to cause a clockwise rotational moment that overcomes any counter-clockwise rotational moment of the walking beam 12. As such, the walking beam 12 rotates clockwise about the rotational axis presented by the pivot portion 18 of the walking beam 12. Such rotation will cause the first blade 20 to be forced downward, remaining embedded within the ground. As such, even with the second blade 22 being forced out of the ground, embodiments provide for the first blade 20 to continue to be at least partially embedded in the ground so as to continue forming the first furrow and to continue depositing first product within the soil. As such, embodiments provide for portions of the agricultural system 10 to continue to be at least partially operational, even while other portions of the agricultural system 10 are forced out of engagement with the ground. Furthermore, such rotational embodiments reduce the chance that the agricultural system 10 will become damaged by obstacles encountered during operation. Embodiments provide such advantages without the need for springs or biasing elements, which would increase the complexity and cost of the agricultural system 10.

Given the agricultural system 10 described above, embodiments of the present invention may include a method for depositing at least two products into soil. The method may comprise one step of providing an agricultural system 10 including a rotatable walking beam 12 with a first blade 20 secured to a front portion 14 of the walking beam 12 and a second blade 22 secured to a rear portion 16 of the walking beam 12. An additional step may include propelling the agricultural system 10 through the soil, such that the first blade 20 forms a first furrow in the soil and the second blade 22 forms a second furrow in the soil. An additional step includes depositing a first product into the first furrow. A further step includes depositing a second product into the second furrow. The method provides for the first product and the second product are deposited into the soil, such that the first product is offset from the second product.

In addition to the benefits disclosed above, the agricultural system 10 of the present invention provide additional benefits, such as: reduced hair pinning of straw in the furrows, low horsepower requirements of the tractor propelling the agricultural system 10, minimal requirements for costly additional fertilizer openers, low penetration force requirements for the first and second blades 20, 22, improved furrow closing, and a reduction in fertilizer immobility. Embodiments also serves to eliminate issues such as soil/mud build up and plugging in wet soils, as well as the potential for seed and fertilizing mixing in loose soil conditions. Such benefits are achieved, inter alia, through use of the walking beam 12, which is configured to support both (1) the first blade 20 used to form the fertilizer furrow, as well as (2) the second blade 22 used to form the seed furrow. As such, embodiments of the present invention provide for the first blade 20 (e.g., disc blade) and the second blade 22 (e.g., shank) to be installed on a common walking beam 12, thereby reducing weight and cost from other agricultural seeders that include separate fertilizer placement coulters or shanks.

In addition, the first blade 20, such as in the form of a disc blade, can be configured to efficiently cut through field residue to form the first furrow. As such, the agricultural system 10 can deposit, via the first product delivery component 58, a first product, such as fertilizer, at a specified depth. Simultaneously, embodiments provide for the second blade 22, such as in the form of shank, to form the second furrow through the compacted soil left by the first blade 20. The second blade 22 is configured to form the second furrow at a specified depth for seed placement therein. It should be understood that the vertical positions of the first blade 20 and the second blade 22 are independently adjustable, such that the furrows formed by the first blade 20 and the second blade 22 can have their depths individually set. Furthermore, because of the rear placement of the second blade 22, the agricultural system 10 can close the first furrow and lift straw residue out of the second furrow, thus, simultaneously preventing seed and fertilizer mixing and straw hair-pinning. A narrow second blade 22, such as a shank, will not be prone to mud build-up in wet soil conditions. Also, the disc scraper 56 can prevent soil/mud build-up on the first blade 20, as well as minimize issues with stranding fertilizers (e.g., phosphate) away from the second furrow that includes the seed therein.

Finally, the particular configurations of the walking beam 12 described herein provides additional benefits. For example, the walking beam 12 is configured to split the force requirements applied by the actuator 64, via the walking beam 12, to the first and second blades 20, 22. Such a splitting of the force requirements promotes durability and longevity of the components of the agricultural system 10. In addition, as was described above, the ability of the walking beam 12 to rotate permits the agriculture system 10 to continue operating efficiently along uneven terrain or in imperfect soil conditions. Furthermore, embodiments of the present invention provide for the draft and penetration forces applied against the agricultural system 10 to be appropriately configured so as to cause a rotational moment about the walking beam 12, which allows the first and/or second blades 20, 22 to remain embedded within the soil even in imperfect soil conditions (e.g., soil with rocks or other obstacles embedded therein).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. An agricultural implement including an agricultural system operable to deposit product into soil, said agricultural system comprising:
a first blade configured to form a first furrow within the soil;
a second blade configured to form a second furrow within the soil; and
a walking beam including a front portion, a rear portion, and a pivot portion between said front portion and said rear portion, wherein said walking beam is configured to rotate about an axis presented by said pivot portion,
said first blade being secured to said front portion of said walking beam,
said second blade being secured to said rear portion of said walking beam.

2. The agricultural implement of claim 1,
each of said blades being vertically shiftable so as to vary a depth of the first furrow and the second furrow, respectively.

3. The agricultural implement of claim 2,
said blades being dimensioned and configured to laterally and vertically offset the first and second furrows.

4. The agricultural implement of claim 3,
said agricultural system including a first product delivery component configured to deposit a first product into the first furrow,
said agricultural system including a second product delivery component configured to deposit a second product into the second furrow.

5. The agricultural implement of claim 4, further comprising:
a first product source selected from one or more of fertilizer and pesticide; and
a second product source comprising crop seeds.

6. The agricultural implement of claim 5,
said first blade projecting lower than said second blade so as to position the first product within the soil lower and laterally offset from the second product.

7. The agricultural implement of claim 5,
said first blade comprising a disc blade,
said second blade comprising a shank.

8. The agricultural implement of claim 7, further comprising:
a laterally extending tool bar,
said agricultural system being supported on the tool bar, with the walking beam extending in at least a substantially fore-and-aft direction.

9. The agricultural implement of claim 8,
said agricultural system including a linkage system operably secured between the tool bar and the walking beam,
said agricultural system including an actuator coupled between the tool bar and the walking beam to provide down-pressure to the walking beam.

10. The agricultural implement of claim 9,
said agricultural system including a pivot member rotatably secured to the walking beam at the pivot portion,
said linkage system and said actuator each being connected between the tool bar and the pivot member.

11. The agricultural implement of claim 10,
said linkage system comprising a 4-bar linkage.

12. The agricultural implement of claim 1,
said first blade comprising a disc blade,
said agricultural system including a first product delivery component configured to deposit a first product into the first furrow,
said agricultural system including a disc scraper secured to said front portion of said walking beam and configured to extend at least partially into the first furrow, wherein said disc scraper is configured to scrape a side of said disc blade to prevent soil from building up on said disc blade, and wherein a portion of said first product delivery component is maintained between said disc scraper and said disc blade.

13. The agricultural implement of claim 12,
said second blade comprising a shank,
said agricultural system including a second product delivery component secured to the shank and configured to deposit a second product into the second furrow.

14. The agricultural implement of claim 13, further comprising:
a first product source selected from one or more of fertilizer and pesticide; and
a second product source comprising crop seeds.

15. The agricultural implement of claim 1,
said blades being dimensioned and configured to laterally and vertically offset the first and second furrows.

16. The agricultural implement of claim 1, further comprising:
a laterally extending tool bar,
said agricultural system being supported on the tool bar, with the walking beam extending in at least a substantially fore-and-aft direction.

17. The agricultural implement of claim 16,
said agricultural system including a linkage system operably secured between the tool bar and the walking beam,
said agricultural system including an actuator coupled between the tool bar and the walking beam to provide down-pressure to the walking beam.

18. The agricultural implement of claim 17,
said agricultural system including a pivot member rotatably secured to the walking beam at the pivot portion,
said linkage system and said actuator each being connected between the tool bar and the pivot member.

19. The agricultural implement of claim 18,
said linkage system comprising a 4-bar linkage.

20. The agricultural implement of claim 1,
said agricultural system further comprising a packer wheel rotatably secured to said rear portion of said walking beam via a wheel arm, wherein said packer wheel is configured to pack down soil over the first furrow and the second furrow.
